(19) United States
(12) Patent Application Publication
(10) Pub. No.: US 2018/0239912 A1
(43) Pub. Date: Aug. 23, 2018

(54) DATA SECURITY METHOD AND LOCAL DEVICE WITH SWITCH(ES)

(71) Applicants: Ivo Icio Alexander Welch, Los Angeles, CA (US); Xiaoli Lily Qiu, Los Angeles, CA (US)

(72) Inventors: Ivo Icio Alexander Welch, Los Angeles, CA (US); Xiaoli Lily Qiu, Los Angeles, CA (US)

(21) Appl. No.: 15/439,929

(22) Filed: Feb. 22, 2017

(51) Int. Cl. G06F 21/60; H04L 29/06

(52) U.S. Cl. CPC G06F 21/604; H04L 63/10

(57) ABSTRACT

A hardware device with switch(es) for enabling or disabling additional protection to secure local data storage is presented. The device can be a separate device from the local data storage, or an integrated local data storage. The separate device version consists of a stand-alone “bridge” hardware device which can limit the host computer's access to a standard local data storage device (such as an SSD or HDD). The integrated version integrates the bridge into the (modified) local data storage device itself. The switch(es) on the invented device can be manually operated or controlled via wires by a second computer which is not the host computer connected to the local data storage to be protected. In the protected mode, firmwares installed on the device and the host computer limit accessibility or capabilities of the local data storage. For example, one or more partitions on the local data storage in the protected mode can become read-only, or write-only, or inaccessible, or accessible only by secretcode (instead of LBA).

### CROSS-REFERENCE TO RELATED APPLICATIONS

Not Applicable

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document is subject to copyright protection under the copyright laws of the United States and of other countries. The owners of the copyright rights have no objection to the facsimile reproduction by anyone of the patent document or the patent disclosure, as it appears in the United States Patent and Trademark Office publicly available file or records, but otherwise reserve all copyright rights whatsoever. The copyright owners do not hereby waive any of their rights to have this patent document maintained in secrecy, including without limitation its rights pursuant to 37 C.F.R. § 1.14.

### BACKGROUND

### 1. Technological Field

This technical disclosure pertains generally to protecting information on Internet servers against remote data theft, more particularly to adding data theft control via an external hardware switch/switches that restricts access to parts of a data storage, with firmware software setup to enable the hardware invention.

### 2. Background Discussion

Security on the Internet represents a tradeoff between cost and functionality. The problem is to offer computer security solutions that are both easy and cheap enough to deploy and maintain, and yet offer enough functionality to accomplish the needed communication in the potential presence of malicious intruders. The difficulty of achieving and maintaining protected computer systems at reasonable cost has been demonstrated by recent highly publicized massive-scale intrusions, such as those perpetrated at Target, eBay, PF Chang's, JP Morgan and many others. Even if careful curation of computers could have prevented these break-ins in the first place, such efforts apparently had too high a cost or human overhead to maintain, despite these entities being large corporations with ample information technology (IT) resources and sophisticated administrators. It is not surprising then that these problems are especially poignant at smaller companies, in which ordinary system administrators are often overwhelmed by the necessity of constant vigilance, maintenance, and security.

The security dilemma in modern systems is made all the more difficult by the complexity of modern operating systems. The typical Microsoft Windows, Apple OSX, or Linux operating systems contain between 50 million (Windows Server 2003) and 400 million (Debian 7) lines of code. Recent Linux kernels alone already consist of about 16 million lines of code in about 16,000 files. However, complexity is just one of many contributing factors, as even programs with short source code (especially security-related complex and “clever” code), is not immune from coding errors that can compromise existing well-maintained computers, as shown by the “heart-bleed” bug. Temporary human security lapses, such as in the DNC email break-in in 2016 can similarly have disastrous consequences. There is a wide agreement that high complexity is a significant contributing factor to computer vulnerability. Ultimately, a robust security solution is only possible with reasonably low complexity. It has to be simple, or it is likely to fail eventually.

Encryption is often used to help address the problem, but this provides a poor solution in many situations for at least two reasons. First, the intruder may intercept the encryption keys. Second, the owners may forget the encryption keys and passwords, and thereby lose access to their own records. If different files have different encryption keys for further security, then the memory requirements on the human operators can increase dramatically. This risk of complete loss of access to the data and inconvenience of retrieving keys may simply be too great to permit the use of encryption, especially on a per-file basis. Moreover, an encryption-key protected device may not be easy to back up, as it may require coordinated retention of encryption keys.

In view of the above, what is needed is a mechanism to prevent wholesale data theft over the Internet by remote attackers that is economically practical, low in complexity, and simple to maintain even by relatively unsophisticated computer administrators. Accordingly, the present disclosure describes a novel computer component which can serve as part of a solution to overcome the shortcomings of prior approaches for securing data on an Internet connected computer. This disclosed technology can be practically implemented at a low cost and complexity. Only modest software changes are required to accommodate this new computer component.

As of 2016, SATA remains the industry standard for physical storage interface, with it and its variants accounting for most storage devices in personal-computer and server-computer installations. Thus, the present disclosure is described in relation to the SATA. SATA is standardized both with respect to hardware connection and software protocol. Modern operating systems ordinarily communicate with SATA devices via the AHCI software protocol, described, e.g., in widely available OS developer manuals, such as http://wiki.osdev.org/AHCI. The present disclosure is equally applicable to SATA's successors, such as those in hardware form-factor successors like SATA Express, PCIe expansion cards, U.2, or M.2. Similarly, although AHCI is the current dominant interface protocol standard, the invention is equally applicable to AHCI's successors, such as NVMe.

The host operating system communicates with its SATA storage device using a software protocol like AHCI. AHCI uses a command block. This block has many possible inputs/outputs that facilitate such functionalities as reading the number of available blocks, device initialization, error handling, status reports, etc. The most immediately relevant elements in the context of the present disclosure are: (a) information whether the request is read or write (or something else); (b) a logical block address (LBA) on the storage device, 48-bit wide for AHCI protocol, that identifies the block on the storage device to be operated on; and (c) a direct-memory-address (DMA) for exchange of data between the storage device and the host computer.

Typically, the computer host operating system sets the LBA index (in the command block), points to a section of its memory (for DMA access), asks the controller to complete the operation, and eventually picks up the result (a returned success or error code, and a DMA transfer). The presented technology is described in terms of an encapsulated abstract interface, in the form of a C program in the following example. All accesses in the following illustrations are assumed to be exactly one block long, but the presented technology easily generalizes to handling shorter or longer-than-one-block requests. The following description is for the purpose of illustrating one embodiment of the technology without placing limitations thereon.

For illustration, the following code fragment shows the abstraction of the computer interface to the SATA storage device. The line numbers in parentheses (and including the parentheses) are not part of the code:

sata-interface.h:
(Line 1) typedef long long LBA;
(Line 2) #define BLOCKLENGTH 16384
(Line 3) typedef char BLOCK[BLOCKLENGTH] ;
(Line 4) #define MAXREALLBA 0x0FFFFFF
(Line 5) typedef enum { RWRITE=1, RREAD=2 } REQ;
(Line 6) // abstracted standard computer to controller request
(Line 7) int computer_receivefrom( REQ *Requesttype,

LBA *LBAindex, BLOCK *dblock ) ;

(Line 8) int computer_signalerror( char *errortext ) ;
(Line 9) // abstracted interface between controller and storage
(Line 10) int disk_readfrom( LBA LBAindex , BLOCK *dblock ) ;
(Line 11) int disk_writeto( LBA LBAindex , BLOCK dblock ) ;
(Line 12) // abstracted interface to pass through requests without unusual
action
(Line 13) int computer_disk_passthrough( REQ requesttype ,

LBA LBAindex , BLOCK *dblock ) ;

Line 1 defines the LBA (logical block address) as a long integer that is large enough to accommodate the LBA range (typically 48 bits, which can be held in a 64-bit long long-integer). Line 2-Line 3 define the length of each block on the drive, here 16 KB. Line 4 defines the highest physically present LBA, which in the example is 0x0FFFFFF. Thus, this SATA device has a base storage capacity of BLOCKLENGTH×MAXREALLBA=256 GB. Line 5 is the code to identify whether the request from the host computer is a read or write. In a real implementation, there would be other possible requests, such as requests to obtain drive status. Functions for communication between the higher-level host computer and the SATA drive controller are prefixed with “computer_*” (Line 7, and Line 8), while functions for communication between the SATA drive controller and the lower-level storage controller functionality are prefixed with “disk_*” (Line 10, and Line 11). The “passthrough” function in Line 13 can be thought of as a facility to pass a computer host request to the ordinary drive controller when the invented device determines that it has no need for intervention in the computer-to-drive communication.

### BRIEF SUMMARY

The technology described herein provides security protection via a low-cost protected storage device. This protection is achieved either via a “bridge” device which is a standalone hardware device and allows the host computer restricted access to the local data storage device (the separate device version), or via a modification on the local data storage device itself (the integrated device version). As part of a re-thought computer architecture, the separate device version or the integrated version is intended to become one component in a more involved and complex security solution on the host computer. The invention is referred to as the “Device”.

This technology implemented with the separate device version requires four components.

(1) An existing local data storage component referred to as the “Drive”, which is either a solid-state drive (SSD), or a hard disk drive (HDD). This Drive is usually attached via a local interface (e.g., but not limited to, SATA, PCI, a USB or a Thunderbolt bridge) to a host computer. This Drive can be a common disk device, such as those manufactured by OEMs like IBM, Seagate, Samsung, Marvell, Sandforce, Toshiba, LSI, Indilinx, Intel, JMicron, etc. Internally, this Drive includes a controller (firmware) and interface chips, as well as the media or solid-state memory on which to record information. This Drive can sometimes itself be constructed from multiple drive components, e.g., to speed up certain operations.

(2) The Device is attached to a host computer. The said host computer is augmented to recognize and operate the Device. The Drive is connected to the Device, and is no longer directly connected to the host computer.

(3) One or more “hardware mode” switches on the Device itself. The said switch(es) can be manually operated by a human operator, or can be controlled by a computer different from the host computer via a connecting cable. This said switch(es) must not be controllable by the host computer. The current mode/state and/or changes of the switch(es) are readable by the firmware installed on the Device.

(4) Specific alterations of the software (the “firmware”) installed on the Device allow functionality in the specifically described manners.

In the integrated version, the Device is created via modifications to the Drive's firmware, augmented with the required switch (FIG. 1). In the separate device version, the Device is attached between the host computer (the motherboard) and the Drive (FIG. 2).

The hardware mode switch on the Device allows a choice between a “non-protected” (naked) setting and a “protected” (safe) setting.

1. Non-protected: In the separate device version of the invention, the Device and the Drive in this mode operate like unmodified common data storage drives. From the perspective of its operating system host, the Device and the Drive combination is then an ordinary storage peripheral. In this mode, computer operating systems typically send or receive data using logical block addresses (LBA), which itself is a large integer, and the Device seeks to satisfy them without further imposed restrictions. In the non-protected mode, the invention offers no benefits beyond what ordinary storage devices already deliver. It is the same for the Device in the integrated version.

2. Protected: In this mode, specific block ranges (referred to as “partitions”) on the Device have different access permissions. In the example discussed in this technology disclosure, the Device notes up to five specific enumerated restrictions: (1) In the first partition, access is restricted to read-only mode; (2) In the second partition, access remains unrestricted; (3) In the third partition, access is restricted to write-once (never overwrite) mode; (4) In the fourth partition, access is no longer permitted by LBA, but instead requires a secretcode; (5) In the fifth partition, access is not possible. Not all restrictions have to be enforced at the same time. Different implementations of the technology may enhance the flexibility by allowing more partitions and access restrictions.

The invention is claimed for a computer device with both protected and non-protected modes. The physical requirements of the Device are themselves commonplace. The said Device is either a hard drive with embedded firmware and pins for possible connections of one or more switches, or an interceding controlling device with one or more switches.

Although the Device could be useful for a non-network connected computer, its principal use is to protect against remote breach on Internet-connected computers.

### BRIEF DESCRIPTION OF THE SEVERAL VIEWS OF THE DRAWING(S)

The disclosed technology will be more fully understood by reference to the following drawings which are for illustrative purposes only:

FIG. 1 is an example embodiment of a separate Device connected in between the motherboard and the storage device.

FIG. 2 is an example embodiment of an integrated Device containing its switches and the storage drive.

### DETAILED DESCRIPTION

The data security protection system of the present disclosure is referred to as the “Device”. This said Device can be either a separate device installed in between the data storage hard-drive and the operating system (host computer motherboard), or an integrated data storage hard-drive.

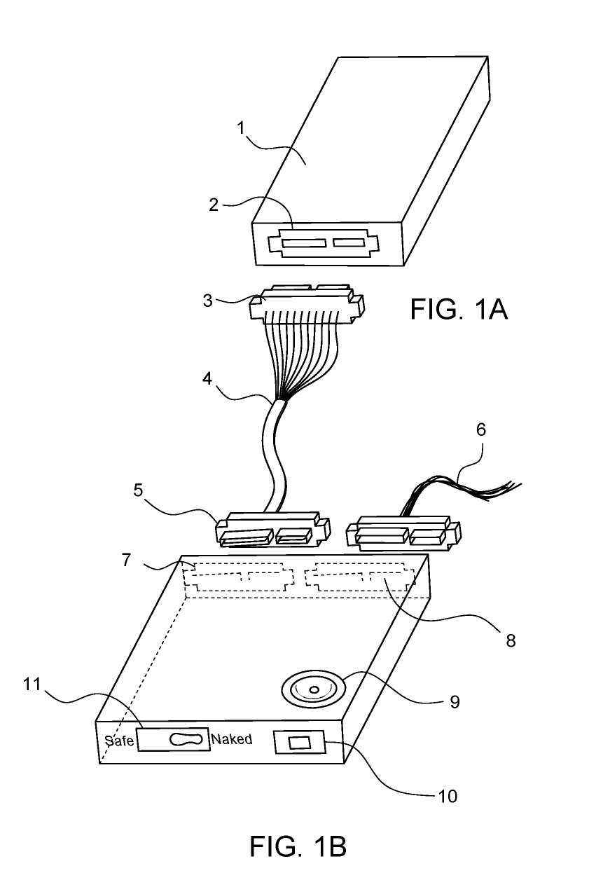

In FIG. 1, the Device is separate from the data storage drive. The storage drive (1) with its SATA port (2) is connected directly via a SATA cable (3, 4, 5) to an equivalent SATA port (7) on the invented Device. (The SATA port and cables, as drawn here, include the power.) The Device itself contains internally a microprocessor-based controller that is capable of communicating both with the storage drive and with the computer motherboard. The Device thus has a second SATA port (8) and connects to the computer motherboard via a second SATA cable (6). In addition, the Device has an external switch, which in this illustration is a mechanical manually-operated switch (11) on the front side of the Device. There is also an optional speaker (9) and LED (10) for further communication with the user.

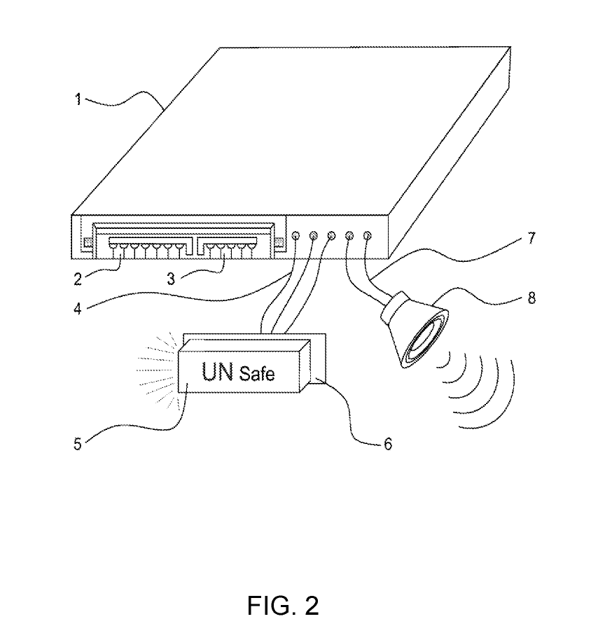

In FIG. 2, the Device is an integrated data storage device 1 . The Device can fit a standard 2.5″ form factor drive with data connector 2 and power connector 3. The Device itself then has a wire 4 connecting to a dip receptacle connectible switch 6, which lights up either “unsafe” or “safe” 5, depending on which state the Device is in, possibly with different color or blinking alert combinations. A speaker 8, which is connected to the Device via wire 7, can further alert the user when the Device is switched into an unsafe state.

In these two illustrations, the switch is not itself physically protected or locked. In some situations, it may be useful not to allow ordinary personnel without a special key to operate it. Such security could be achieved through a special switch hardware connector and/or the requirement of a secret unlock key to be sent to the Device from the host computer. The switch could also be controlled by a separated computer via a connecting cable.

The Device can be thought of as providing an intermediate layer of hardware and software between the hosting computer operating system and the data storage device. Its firmware must not run on the host computer, because it must not be changeable by the host computer when in safe mode. Instead, its firmware must run either on its own controller when the invented Device is separate from the data storage, or on the controller of the data storage device when the invented Device is an integrated data storage hard-drive. The controller firmware receives the request from the host operating system to the Device, inspects it, and then either passes it on to the standard data storage controller (in the separate device version) or initiates a different behavior.

In this embodiment of the technology, there are five partitions on the data storage drive, which include four restricted partitions. Their base definitions are as the following:

storage.h:
(Line 14) #define NPARTS 5
(Line 15) typedef enum { RO=0, RW=1, WO=2, SC=3, NA=4, END=5 } PTYPE ;
(Line 16) LBA blookends[NPARTS+1]; // storage
(Line 17) // Write-once (WO) partition-related definitions
(Line 18) LBA WOlast ; // lba storage pointer , >=(blockends[RW]+1) ,

<=blockends[WO]

(Line 19) // secretcode (SC) partition-related definitions
(Line 20) #define SECRETCODESTART 0
(Line 21) #define SECRETCODELENGTH 512
(Line 22) typedef char

SECRETBLOCK[SECRETCODELENGTH-SECRETCODESTART];

(Line 23) // pseudo LBA requests to signal secretcode operation
(Line 24) typedef enum { NEW=LONG_MAX−10, RPLC , READ, DEL }

PSEUDOLBA;

In this illustration, Line 14 defines five distinct regions. The order of the five partitions on disk is fixed. Line 15 defines these partition facilities: (1) RO: The first partition (block range), which usually includes the boot partition in many modern operating systems (and the UEFI specification), can be read-only; (2) RW: The second partition can be unrestricted and always accessible, regardless of the current mode of the Device; (3) WO: The third partition can be write-once; (4) SC: The fourth partition can provide accessibility by secretcode instead of LBA; (5) NA: The fifth and last partition can be inaccessible in the protected mode, beyond the SC blockend and in the protected mode, LBA requests result in errors. Beyond the NA blockend, LBA requests are meaningful only for pseudo-requests (defined below). For programming convenience, there is an “END” indicator on Line 15 to signal the end of the physical LBA range.

In this illustration, the first partition is assumed to begin at LBA 0, the remaining partitions begin where the previous partition ends. Thus we need only a single LBA value (Line 16) per partition to define which part of the drive is allocated to which restriction. It is envisioned that the partition locations and restrictions can be modified when the Device is in the non-protected mode.

In addition, it is convenient in coding to define a WOlast LBA that stores the destination of the next free block on the write-once partition (Line 17-Line 18). It is envisioned in one implementation that the computer host decides what blocks are valuable enough to deserve copying to this partition. In another implementation, the Device itself can enforce a rule that all block write requests, which were not overwritten within a predetermined amount of time (to avoid needless recording of temporary files), would be written to the WO partition. Data deduplication integrated into the Device could further preserve limited space on this partition without compromising security.

The remaining lines, beginning with Line 19, relate to the fourth “SC” partition, which allows access only via secretcode and not via LBA in the protected-mode. Consider a case in which the host operating system wants to signal its desire to read a block identified by a secretcode. A secretcode string is usually considerably longer than 64 bits. The ordinary protocols (like AHCI) may not facilitate such long “string id” based requests (only the 48 bit integer LBAs). Thus the protocol must be extended to accommodate the long secretcode access method. (In another implementation, the AHCl/NVMe protocol itself could be replaced altogether. In yet another implementation, multiple LBA requests could serve to signal the secretcode.)

To keep the illustrated implementation simple, here the direct memory access (DMA) payload is altered to send the secretcode from the host computer to the Device. From the perspective of the host operating system, all secretcode requests (whether they are read or write) are sent as MCI write requests to predefined non-existent “pseudo” LBAs, with the actual secretcode and the payload both in DMA.

The relevant DMA block payload when the host computer signals a read-from-storage request is just the secretcode. The rest of the DMA block payload that is passed from the host operating system is ignored, and will be overwritten by the Device's returned storage contents. The relevant block payload when the computer host signals a request for a write-to-storage contains both the secretcode and the remaining payload.

For read-from-storage requests, the Device first reads the data from the computer DMA, inspects the secretcode in the payload, and scans through its “SC” partition for a match. If the secretcode from the host computer corresponds to a secretcode on the partition, the Device reads the data on the block identified by this secretcode, then uses the DMA a second time for sending the data back from the Device to the computer operating system. If there is no corresponding secretcode on the “SC” partition, the Device can signal a (write) error to the operating system.

In this illustration, the secretcode within each 16 KB data payload block occupies the first 512 bytes (Line 20-Line 21). A typical secretcode may be a user password or a random string, and would fit in a specific memory area (Line 22).

This particular embodiment of the invention understands four secretcode instructions for the SC partition. They are coded as pseudo-LBA write requests to non-existent sectors (Line 23). Thus, they signal new commands to the storage device, rather than requests to write to these (non-existing physical) LBAs. The four pseudo-LBAs are defined in Line 24 and abbreviated as: NEW write data but do not allow overwrite; RPLC replace data; READ read data; DEL delete data. In an alternative embodiment, these command requests could be passed in DMA (e.g., in the first byte of the secretcode).

The Device also needs to be able to understand whether the switches are set to allow or to restrict access:

externalswitch.h:
(Line 25) int externalswitch_readstate( ) ;
(Line 26) #define NONSECURE 0
(Line 27) #define SECURE 1

In this illustration, a human operator (or a second computer) can switch the Device (Line 25) between the non-protected (naked) mode (Line 26) and the protected (safe) mode (Line 27). In a different embodiment, the naked mode could time out or time out only after no restricted operation has been used for a while, which protects against inadvertently leaving the Device in the non-protected (naked) mode. It is also recommended that the Device emits a warning sound while the Device is in the non-protected mode (to remind the user to return to the protected mode). Similarly, the Device could or should emit a (different) warning sound when illegal access attempts to the Device occur. In another implementation, switching to the non-protected (naked) mode would require not only the switch operation, but also a password on the host computer.

The Device itself runs an eternal loop (Line 28) that monitors requests from the host operating system or waits for an interruption, and then satisfies them. For illustrative purpose, one implementation is as the following:

eternalloop.c:
(Line 28) void eternal _ loop ( ) {
(Line 29) while ( true ) {
(Line 30) BLOCK datablock ; LBA lbaindex ; REQ reqtype ;
(Line 31) computer_receivefrom( &reqtype , &lbaindex , &datablock ) ;
(Line 32) if ( lbaindex >= LONG_MAX−10) {
(Line 33) // a pseudo-LBA request , i.e., secretcode in datablock
(Line 34) handlesecretcoderequest ( blockends [SC−1] , lbaindex , &datablock ) ;
(Line 35) continue ;
(Line 36) }
(Line 37) int ext_switch = externalswitch_readstate ( ) ;
(Line 38) if ( ext_switch == NONSECURE) {
(Line 39) computer_disk_passthrough ( reqtype, lbaindex , &datablock ) ;
(Line 40) continue ;
(Line 41) }
(Line 42) int ptid ; // look up the partition for access permission
(Line 43) for ( ptid=0; ptid<=NPARTS; ++ptid )
(Line 44) if ( lbaindex < blockends [ ptid ] ) break ;
(Line 45) switch ( ptid ) {
(Line 46) case RW:
(Line 47) computer_disk_passthrough ( reqtype , lbaindex , &datablock ) ;
(Line 48) continue ;
(Line 49) case RO:
(Line 50) if ( reqtype != RREAD) computer_signalerror ( “read not permitted” ) ;
(Line 51) computer_disk_passthrough ( reqtype, lbaindex , &datablock ) ;
(Line 52) continue ;
(Line 53) case WO:
(Line 54) if ( reqtype == RWRITE) {
(Line 55) lbaindex= WOlast ;
(Line 56) if ( (WOlast<blockends [RW] ) || ( lbaindex>=blockends [WO] ) )
(Line 57) computer_signalerror ( “internal error or write-once storage exhausted” ) ;
(Line 58) }
(Line 59) computer_disk_passthrough ( reqtype , lbaindex , &datablock ) ;
(Line 60) write_WOlast2disk (WOlast ) ;
(Line 61) continue ;
(Line 62) case SC:
(Line 63) computer_signalerror ( “protected SC region” ) ;
(Line 64) case NA: default:
(Line 65) computer_signalerror ( “unmarked disk partition” ) ;
(Line 66) }
(Line 67) }
(Line 68) }
(Line 69) void initialize_device ( ) {
(Line 70) assert ( sizeof (LBA) >= 48 ) ;
(Line 71) assert ( SECRETCODELENGTH <= BLOCKLENGTH ) ;
(Line 72) read_partitions_and_WOlast ( blockends ) ;
(Line 73) }

In Line 31, the Device receives a request from the host computer and inspects it. If the LBA is beyond the maximum allowed address, both in the protected and the non-protected mode, the Device recognizes this as a pseudo-request. Such requests are immediately handed to the secretcode request handler at Line 32. The details of this handler will be discussed further in paragraph [0059]. Once satisfied, the eternal loop starts anew at Line 35.

Next the Device determines whether the switch is in the non-protected mode—i.e., the naked mode that should allow all operations (Line 37-Line 38)—in which case it hands the request through to the underlying storage device (Line 39) and the loop starts anew (Line 40).

The program is now in a place where the request has not been a pseudo-request (secretcode request), and where the switch is in the protected mode. The Device must now look up in what partition the request lies (Line 42, Line 43, and Line 44). In a different embodiment, for example, the partitions could be identified by the host computer instead of being implicit in the LBA, then the Device can check the LBA directly within the partition that it is directed to.

If in the protected mode the LBA request is for a block within the effectively unrestricted read-write partition (Line 46), it will be passed on to the storage sub-system (Line 47), and the loop starts anew (Line 48).

If in the protected mode the LBA request is for a block within the read-only partition (Line 49), requests that are not READ result in an error message (Line 50). If it is a read request, then it will be passed on to the storage sub-system (Line 51). The loop starts anew at Line 52.

If in the protected mode the LBA request is for a block within the write-once partition (Line 53), then the write request (Line 54) appends the data block after the last written block. With the WOlast LBA (Line 55) information, the write access to this partition continues where the most recent one has left off. The next steps (Line 56-Line 57) make sure that there is a write-once storage and that the write-once storage has not yet been filled up. Then, the write request is passed through (Line 59) and the loop can start anew (Line 61).

It must be assured that the WOlast LBA is preserved through sudden power-offs. Thus Line 60 saves this LBA to the non-volatile memory. Preferably, this would be exceedingly fast non-volatile memory on the Device controller itself and not on the storage sub-system. In this implementation, the read access to the write-once partition is always permitted (Line 60), but in another implementation this read access could be prohibited.

In this implementation, the write-once operation is requested by the host computer. In one alternative implementation, the Device could itself log all write requests automatically, or all write requests which are not overwritten within a timeout period to reduce space needs for writing temporary or cache files.

In this implementation, in the protected mode if the request is for an LBA in the SC(secretcode protected) partition (Line 62), it results in an error (Line 63), because such access is allowed only through secretcodes.

In this implementation, in the protected mode if the LBA request is for a block within the non-accessible partition (Line 64), requests result in an error (Line 65).

If the main loop has determined that the data request is not via LBA but via secretcode for a block that lies in the secretcode-protected range, it invokes the secretcode handler which can be illustrated as following.

```
secretcodehandler.c:
(Line 74) int handlesecretcoderequest( LBA blockstartofscsection,
(Line 75)  LBA lbaindex_pseudo, BLOCK *datablock ) {
(Line 76)  SECRETBLOCK*secretcode=( SECRETBLOCK * )
            &( datablock[SECRETCODESTART] );
(Line 77)  LBA lbaindex_real=
(Line 78)  disk_secretcode2lbaindex( blockstartofscsection,
                secretcode );
(Line 79)  switch ( lbaindex_pseudo ) {
(Line 80)  case RPLC:
(Line 81)  if ( lbaindex_real )
(Line 82)  return disk_writeto( lbaindex_real, * datablock );
(Line 83)  case NEW:
(Line 84)  if ( lbaindex_real )
(Line 85)  return computer_signalerror( “overwrite not allowed” );
(Line 86)  lbaindex_real=disk_protectedfindempty( blockends[WO]+
1 );
(Line 87)  if ( !lbaindex_real )
(Line 88)  return computer_signalerror( “no space left” );
(Line 89)  return disk_writeto( lbaindex_real , *datablock );
(Line 90)  case READ:
(Line 91)  if ( !lbaindex_real )
(Line 92)  return computer_signalerror( “unknown secretcode” );
(Line 93)  return disk_readfrom( lbaindex_real, datablock );
(Line 94)  case DEL :
(Line 95)  if ( !lbaindex_real )
(Line 96)  return computer_signalerror ( “unknown secretcode” );
(Line 97)  return disk_protecteddelete( lbaindex_real );
(Line 98)  defaul t:
(Line 99)  return computer_signalerror( “unknown pseudo lba
                request” );
(Line 100)  }
(Line 101) }
```

The secretcode request handler inspects the secretcode component of the DMA datablock (Line 74-Line 75). The remaining payload can be ignored by this handler. For clarity, the secretcode block data itself is broken out (Line 76). The handler first looks up whether the secretcode exists anywhere on any block within the SC partition (Line 77-Line 78). Then it looks up what the pseudo LBA request is asking for (Line 79). If the request is a RPLC command (Line 80) and a block with this secretcode exists (Line 81), then no new block needs to be allocated, the current block is overwritten, and the operation is complete (Line 82). If the secretcode does not exist, the RPLC operation proceeds as if it is a NEW write request (Line 83). For the NEW request, if there is already a block with that particular secretcode in the request, then overwriting is not permitted and the function returns an error (Line 84-Line 85). With the NEW write request when there is no existing block with that particular secretcode in the request, the handler first finds an empty LBA block within the SC partition (Line 86), aborts if there is none available (Line 87-Line 88), then writes the entire data to the available block (Line 89). With a READ request (Line 90), the handler returns an error if the secretcode in the request is not found on the partition (Line 91-Line 92), and returns the block contents if this secretcode is found on the partition (Line 93). With a DEL request (Line 94), the handler returns an error if the secretcode in the request is not found on the partition (Line 95-Line 96), and erases the block contents if this secretcode is found on the partition (Line 97). Finally, other requests (Line 98) elicit an error (Line 99).

For completeness, a very inefficient illustration of the secretcode-LBA map software follows. This and more efficient techniques are well understood.

```
map.c:
(Line 102) #define ERROR 0
(Line 103) LBA disk_secretcode2lbaindex( LBA startofscsection,
                SECRETBLOCK *secretcode ) {
(Line 104)  LBA l;
(Line 105)  for ( l=startofscsection; l<MAXREALLBA; ++l ) {
(Line 106)  BLOCK tb;
(Line 107)  if ( disk_readfrom( l , &tb ) == ERROR) return ERROR;
(Line 108)  if ( bcmp( tb+SECRETCODESTART, secretcode,
                SECRETCODELENGTH)==0) return I;
(Line 109)  }
(Line 110)  return ERROR;
(Line 111) }
(Line 112) LBA disk_protecteddelete( LBA delme ) {
(Line 113)  BLOCK zeros;
(Line 114)  bzero ( zeros, BLOCKLENGTH );
(Line 115)  if ( disk_writeto( delme, zeros) == ERROR) return ERROR;
(Line 116)  return delme;
(Line 117) }
(Line 118) LBA disk_protectedfindempty( LBA startofscsection ) {
(Line 119)  LBA l;
(Line 120)  for ( l=startofscsection; l<MAXREALLBA; ++l ) {
(Line 121)  BLOCK tb;
(Line 122)  if ( disk_readfrom( l, &tb ) == ERROR) return ERROR;
(Line 123)  bool balliszero( ) ; // prototype
(Line 124)  if( balliszero( tb+SECRETCODESTART,
                SECRETCODELENGTH ) ) return I ;
(Line 125)  }
(Line 126)  return ERROR;
(Line 127) }
```

This illustration shows that the secretcode could be searched for in the protected block range (Line 103-Line 111), deleted by zeroing the entire block (Line 112-Line 117), and new blocks can be allocated by searching for completely empty blocks (Line 118-Line 127). However, this sample illustration would not be appropriate in a real implementation. In practice, the Device should build an internal lookup table (secretcode!LBA) to respond more quickly to secretcode requests. Such a table would map each secretcode to one logical block in the protected range of the Device. In this case, read requests do not require slow sequential access to each and every block. The actual implementation will depend on the memory storage capacity, device speed of the device controller, and the amount of secretcode data that must be searched.

There are many implementation variations on this secretcode partition.

For example, in the SC partition, it would be possible to increase the storage speed by pre-formatting (initializing) the protected region with random code strings. In this example, NEW and RPLC requests would not be accompanied by a secretcode, but instead would return a predetermined secretcode. This predetermined secret key then becomes the secretcode that is needed for later payload retrieval. There are however tradeoffs. This method could speed up access, because the Device and the secretcode-LBA map can be pre-optimized. It can also offer more protection because the random generation of the secret keys reduces the likelihood of the keys being guessable.

In another implementation, the codes can be provided by the user (e.g., computed based on users' biometric information and passwords).

Incorrect secretcode access requests could result in reduced access speeds in an attempt to slow down brute-force attacks. More sensibly, incorrect access attempts could trigger audible or visible alerts that require manual operation to turn off in the protected mode. The Device could also turn off and lock to restrict access after a pre-determined number of wrong attempts.

The current invention is designed to be part of a storage architecture that helps protect data storage against intrusion. In the illustrated implementation, the Device has multiple partitions that act in different ways.
1) The first partition is a read-only area in the protected mode. This partition also includes the boot block and boot area. Being read-only in the protected mode, it is hardened against unauthorized operating system alteration by viruses, malware, sentries, and other malicious software.
2) The second partition is a standard read-write area in the protected mode, and it should be deemed unsafe. Files in this partition can be individually protected with file-specific encryption keys, with these keys stored in the separate secretcode-protected partition. In many cases, it would make sense to mark this partition as noexec (i.e., not permitted to execute code), and not only for binaries, but also via operating system and language modifications to guard against interpreted language use (such as sh, perl, php, java, etc.).
3) The third partition is a write-once area in the protected mode. It is designed to help protect against ransomware attacks, which encrypt the user's storage and then blackmail the owner to pay to obtain the decryption password. The operating system would keep a log of write operations to this Device. It can also serve to provide an unalterable audit trail. It is a natural destination for log files and backups.
4) The fourth partition is a secretcode-accessible-only area in the protected mode, which is described in most details in this current disclosure. It could be used, e.g., to store file-specific encryption keys for the other block ranges, which are retrievable only in emergencies through switching the Device into the non-protected (naked) mode. It could also provide a write-only and non-readable destination (e.g., for credit-card transactions) in the protected mode. Or it could be a write-only and readable partition. The key advantage of secretcode over existing encryption is that there are no encryption keys that can be irretrievably forgotten. For good security, users can be advised never to switch to the non-protected mode on the same computer, but to move the Device and use it only on air-gapped computers. This can further be enforced by locking the switch in the “protected” (safe) position on the internet-facing computer, forcing the user to remove the Device from the internet-facing computer before entering the non-protected mode.
5) The fifth partition is not accessible in the protected mode.

Further, the host operating system should gain certain access rights to the Device only when the protected switch is off:
1) Update the Device's firmware;
2) Re-initialize the Device, or reset the partition size allocations on the Device;
3) Change certain behaviors, such as the type of audio warnings that the Device emits when in non-protected mode or when there is an illegal access attempt.

The hardware switch itself can be designed to be a static toggle switch, i.e., a switch that needs to be physically held by the user for the entire time of the operation, or can be a switch that turns itself back to “protected” mode after a timeout period. It could be a physical switch that requires a human operator to manually turn on or off, or a set of wires to connect the Device to a second computer (different from the host computer and preferably not connected to the internet) which can operate the switch. It is recommended that there be a low-level audio signal to indicate to the user when the Device is in the non-protected mode.

With the current invention, it is possible to modify operating systems that are based on common operating systems (like linux) for the Device to boot and function properly (just like a CD-ROM can boot and function under linux), and also add additional and more protected storage facilities.

An important aspect of the current invention is its low code complexity, both on the host operating system and on the Device. The required code base is measured in hundreds of lines of computer codes (and auditable), not millions of lines of computer codes. When a security code is as complex as it is in general-purpose computer systems, inadvertent code vulnerabilities commonly lead to breaches. Any high-complexity device can itself become another point of vulnerability, just like general-purpose computers on networks can become vulnerable. It is the special-purpose fixed-function controller nature of the Device that gives it its security.

A very important and useful aspect of the current invention is that it does not require encryption keys which may be lost and render data in storage unusable forever. The system administrator can always gain back the complete access to the keys and values.

What is claimed is:

1. An apparatus for securing a data storage accessed through an internet-facing host computer, with multiple embodiments:
(a) one embodiment is an apparatus separate from the data storage to be protected, the said apparatus has a switch or switches which can be manually operated or can be controlled by a second computer via a connecting cable, and the said apparatus is connected to both the data storage and the internet-facing host computer;
(b) another embodiment is an integrated apparatus, the said apparatus is a data storage drive augmented with a switch or switches which can be manually operated or can be controlled by a second computer via a connecting cable;
(c) other embodiments utilizing the disclosed technology.

2. The apparatus recited in claim 1, wherein there are many partitions on the data storage with different accessibility or capabilities in the protected mode:
(a) one or more partitions in the protected mode can be un-accessible by LBA and accessible by secretcode;
(b) one or more partitions in the protected mode can write only once;
(c) one or more partitions in the protected mode can be un-accessible at all;
(d) one or more partitions in the protected mode can be read-only;
(e) one or more partitions in the protected mode can be unrestricted;
(f) one or more partitions in the protected mode can have other restrictions not mentioned from (a) to (e).

3. The apparatus recited in claim 1, wherein specific alterations of the software installed on the said apparatus and the host computer allow the said apparatus to function as described.
